(19) United States
(12) Patent Application Publication
(10) Pub. No.: US 2013/0047850 A1
(43) Pub. Date: Feb. 28, 2013

(54) SYNTHESIS GAS PURIFICATION BY SELECTIVE COPPER ADSORBENTS

(71) Applicants: Vladislav I. Kanazirev, Arlington Heights, IL (US); Jayant K. Gorawara, Buffalo Grove, IL (US)

(72) Inventors: Vladislav I. Kanazirev, Arlington Heights, IL (US); Jayant K. Gorawara, Buffalo Grove, IL (US)

(73) Assignee: UOP LLC, Des Plaines, IL (US)

(21) Appl. No.: 13/218,031

(22) Filed: Aug. 25, 2011

(51) Int. Cl. B01D 53/02

(52) U.S. Cl. 95/134; 95/133; 95/116; 95/135

(57) ABSTRACT

Effective synthesis gas purification is achieved by applying copper adsorbents which are resistant to the reduction by the components of the synthesis gas H₂ and CO at normal operation conditions. The novel adsorbents are produced by admixing small amounts of an inorganic halide, such as NaCl, to the basic copper carbonate precursor followed by calcination at a temperature sufficient to decompose the carbonate. The introduction of the halide can be also achieved during the forming stage of adsorbent preparation. These reduction resistant copper oxides can be in the form of composites with alumina and are especially useful for purification of synthesis gas or gas streams containing hydrogen carbon monoxide or other reducing agents.

### BACKGROUND OF THE INVENTION

The term synthesis gas designates mixtures of carbon monoxide (CO) and hydrogen (H₂) in varying proportion which often contain carbon dioxide (CO₂), and water (H₂O). The most typical process of synthesis gas production consists of high temperature reforming of natural gas or other hydrocarbon feeds. The synthesis gas is then fed to different catalytic processes such as low and high temperature water shift reactions which are susceptible to catalytic poisons, mainly H₂S and COS. Copper containing catalysts are widely used to catalyze the low temperature water shift reaction. The water shift reaction in which carbon monoxide is reacted in presence of steam to make carbon dioxide and hydrogen as well as the synthesis of methanol and higher alcohols are among the most practiced catalytic processes nowadays. Both processes employ copper oxide based mixed oxide catalysts. Producing synthesis gas from coal is another commercial technology. In this case the product stream contains a range of contaminants, with arsine (AsH₃) being the most detrimental for the catalytic processes downstream. A typical raw synthesis gas stream contains about 0.5 to 1.0 ppm arsine. Coal derived synthesis gas may in some instances contain mercury and heavy metals as contaminants.

Copper-containing sorbents play a major role in the removal of contaminants, such as sulfur compounds and metal hydrides, from gas and liquid streams. One new use for such sorbents involves the on-board reforming of gasoline to produce hydrogen for polymer electrolyte fuel cells (PEFC). The hydrogen feed to a PEFC must be purified to less than 50 parts per billion parts volume of hydrogen sulfide due to the deleterious effects to the fuel cell of exposure to sulfur compounds.

The active copper phase for the removal of sulfur compounds from synthesis gas can be derived from copper compounds, mainly in carbonate, oxide and hydroxide form or mixture thereof. Copper adsorbents for synthesis gas are usually porous solids with well developed pore structure and appreciable surface area. Inorganic supports or binders can be used to provide for physical stability and durability at the process conditions of synthesis gas purification

The high temperature process of production and purification of synthesis gas require frequently adding hydrogen sulfide in order to prevent metal dusting corrosion which is known to occur at temperatures over 300° C. Meanwhile, H₂S is poisonous to the downstream catalysts and needs to be removed at a level of about 20 ppb.

Copper oxide containing adsorbents are well suited for synthesis gas purification provided that they maintain the oxide state. Unfortunately, the reducing agents contained in the synthesis gas, such as CO and H₂, can trigger the reduction of the oxide to the copper metal which is less suited for contaminant removal. A further detriment to the reduction process is that heat is liberated which may result in runaway reactions and other safety concerns in the process.

Use of CuO on a support that can be reduced at relatively low temperatures is considered to be an asset for some applications where it is important to preserve high dispersion of the copper metal. According to U.S. Pat. No. 4,863,894, highly dispersed copper metal particles are produced when co-precipitated copper-zinc-aluminum basic carbonates are reduced with molecular hydrogen without preliminary heating of the carbonates to temperatures above 200° C. to produce the mixed oxides.

However, easily reducible CuO is disadvantageous in the purification of synthesis gas. The removal of hydrogen sulfide (H₂S) from gas streams at elevated temperatures is based on the reaction of CuO with H₂S. Thermodynamic analysis shows that this reaction results in a low equilibrium concentration of H₂S in the product gas even at temperatures in excess of 300° C. The residual H₂S concentration in the product gas is much higher (which is undesirable) when CuO reduces to Cu metal in the course of the process since reaction (1) is less favored than CuO sulfidation to CuS.

2Cu+H₂S=Cu₂S+H₂ (1)

Combinations of CuO with other metal oxides are known to retard reduction of CuO. However, this is an expensive option that lacks efficiency due to performance loss caused by a decline of the surface area and the lack of availability of the CuO active component. The known approaches to reduce the reducibility of the supported CuO materials are based on combinations with other metal oxides such as Cr₂O₃. The disadvantages of the approach of using several metal oxides are that it complicates the manufacturing of the sorbent because of the need of additional components, production steps and high temperature to prepare the mixed oxides phase. As a result, the surface area and dispersion of the active component strongly diminish, which leads to performance loss. Moreover, the admixed oxides are more expensive than the basic CuO component which leads to an increase in the sorbent's overall production cost.

Another known approach to deal with the reducibility of the Cu based adsorbents is to pre-reduce them before introduction in the synthesis gas purification service. This approach has been described in the U.S. Pat. No. 7,323,151 in the case of the removal of S compounds. The use of the reduced Cu sorbent for arsine removal from synthesis gas is described by Robert Quinn et al in the article “Removal of Arsine from Synthesis Gas Using a Copper on Carbon Adsorbent” published in 2006 in IND. ENG. CHEM. RES, vol. 45, pages 6272 to 6278.

The pre-reduction approach has the disadvantage of lower capacity for contaminant removal compared to the copper in oxide form. In addition, the residual content of contaminants such as hydrogen sulfide is relatively high due to the low equilibrium constant.

The present invention provides a new method for purification of synthesis gas by using Cu based adsorbent produced by addition of a small amount of a salt, such as sodium chloride (NaCl) to a copper precursor such as basic copper carbonate (CuCO₃.Cu(OH)₂) used as a source of the copper active phase in the adsorbent preparation. The final adsorbent produced by calcination of the precursor at temperatures suitable to convert the carbonate to the oxide, has been found to significantly resist the reduction by the synthesis gas components such as hydrogen. An increase of the calcination temperature of the basic copper carbonate (abbreviated herein as “BCC”) beyond the temperature needed for a complete BCC decomposition also has a positive effect on CuO resistance towards reduction, especially in the presence of Cl.

Surprisingly, it has now been found that calcination of intimately mixed solid mixtures of basic copper carbonate (abbreviated herein as “BCC”) and NaCl powder led to a CuO material that was more difficult to reduce than the one prepared from BCC in absence of any salt powder.

### SUMMARY OF THE INVENTION

The present invention offers a method for purification of synthesis gas using copper adsorbents, in particular CuO containing copper adsorbents supported on a porous carrier wherein the resistance of CuO against reduction by the synthesis gas component has been increased by the addition of small amounts of an inorganic halide, such as sodium chloride to the Cu precursor—basic copper carbonate followed by calcinations for a sufficient time at a temperature in the range 280° to 500° C. that is sufficient to decompose the carbonate. These reduction resistant adsorbents show significant benefits in the removal of sulfur and other contaminants from synthesis gas. These adsorbents are particularly useful in applications where the adsorbents are not regenerated. Sulfur contaminants that are removed include H₂S, light mercaptans and COS. Mercury and mercury compounds can also be removed. The sorbents of the present invention operate to remove sulfur, arsine and phosphine from synthesis gas at near ambient temperatures (10° to 45° C.). These materials do not cause run away reactions by contact with synthesis gas components at normal process conditions.

### BRIEF DESCRIPTION OF THE DRAWINGS

FIG. 1 is a comparison of the reduction curves of the adsorbent according the invention ADS-INV and a reference adsorbent ADS-REF which does not contain chloride. The reduction process is followed by the evolution of the product water

FIG. 2 is a comparison of the reduction of the adsorbent according the invention ADS-INV and the reference material ADS-REF. The reduction is followed by the decrease of the pressure due to H2 consumption

### DETAILED DESCRIPTION OF THE INVENTION

Basic copper carbonates such as CuCO₃.Cu(OH)₂ can be produced by precipitation of copper salts, such as Cu(NO)₃, CuSO₄ and CuCl₂, with sodium carbonate. Depending on the conditions used, and especially on washing the resulting precipitate, the final material may contain some residual product from the precipitation process. In the case of the CuCl₂ raw material, sodium chloride is a side product of the precipitation process. It has been determined that a commercially available basic copper carbonate that had both residual chloride and sodium, exhibited lower stability towards heating and improved resistance towards reduction than another commercial BCC that was practically chloride-free.

In some embodiments of the present invention, agglomerates are formed comprising a support material such as alumina, copper oxide and halide salts. The alumina is typically present in the form of transition alumina which comprises a mixture of poorly crystalline alumina phases such as “rho”, “chi” and “pseudo gamma” aluminas which are capable of quick rehydration and can retain substantial amount of water in a reactive form. An aluminum hydroxide Al(OH)₃, such as Gibbsite, is a source for preparation of transition alumina. The typical industrial process for production of transition alumina includes milling Gibbsite to 1 to 20 microns particle size followed by flash calcination for a short contact time as described in the patent literature such as in U.S. Pat. No. 2,915,365. Amorphous aluminum hydroxide and other naturally found mineral crystalline hydroxides e.g., Bayerite and Nordstrandite or monoxide hydroxides (AlOOH) such as Boehmite and Diaspore can be also used as a source of transition alumina. In the experiments done in reduction to practice of the present invention, the transition alumina was supplied by the UOP LLC plant in Baton Rouge, La. The BET surface area of this transition alumina material is about 300 m²/g and the average pore diameter is about 30 Angstroms as determined by nitrogen adsorption.

In the present invention, a copper oxide sorbent is produced by combining an inorganic halide with a basic copper carbonate to produce a mixture and then the mixture is calcined for a sufficient period of time to decompose the basic copper carbonate. The preferred inorganic halides are sodium chloride, potassium chloride or mixtures thereof. Bromide salts are also effective. The chloride content in the copper oxide sorbent may range from 0.05 to 2.5 mass-% and preferably is from 0.3 to 1.2 mass-%. Various forms of basic copper carbonate may be used with a preferred form being synthetic malachite, CuCO₃Cu(OH)₂.

The copper oxide sorbent that contains the halide salt exhibits a higher resistance to reduction than does a similar sorbent that is made without the halide salt. The copper oxide sorbent of the present invention is useful in removing arsenic, phosphorus and sulfur compounds from synthesis gas or from thye individual components of the synthesis gas at suitable conditions. In addition, the sorbent is useful in applications where the adsorbent is not regenerated. The removal of H₂S, light mercaptans and COS is an advantageous use of the adsorbent. Mercury can also be removed by this adsorbent.

Hydrogen sulfide (H₂S), carbonyl sulfide (COS), arsine (AsH₃) and phosphine (PH₃) can be successfully removed from synthesis gas at nearly ambient temperature in the advanced processes of methanol production such as a liquid phase methanol process (LPMEOH) using guard beds containing supported CuO provided that the active phase CuO does not reduce to Cu metal in the course of the removal process. Typically, the synthesis gas contain 68% H₂, 23% CO, 5% CO₂ and 4% N₂ at a pressure of about 51,711 kPa (7500 psig) and GHSV (gas hourly space velocity) of 3000 to 7000 hr⁻¹. The adsorbent according the invention would resist the reduction of CuO.

Table 1 lists characteristic composition data of three different basic copper carbonate powder samples designated as Samples 1, 2 and 3.

TABLE 1

| Composition, | Sample Number | | |
|---|---|---|---|
| Mass-% | 1 | 2 | 3 |
| Copper | 55.9 | 55.4 | 54.2 |
| Carbon | 5.0 | 5.1 | 5.1 |
| Hydrogen | 1.3 | 1.2 | 1.2 |
| Sodium | 0.23 | 0.51 | 0.51 |
| Chloride | 0.01 | 0.32 | 0.28 |
| Sulfate | 0.06 | 0.01 | 0.02 |

All three samples were subjected to thermal treatment in nitrogen in a microbalance followed by reduction in a 5% H₂-95% N₂ stream. As the thermogravimetric (TG) analysis showed, chloride-containing BCC Samples 2 and 3 decompose to CuO at about 40° to 50° C. lower temperatures than Sample 1. On the other hand, the latter sample was found to reduce more easily in presence of H₂ than the Cl-containing samples. The reduction process completed with Sample 1 at 80° to 90° C. lower temperature than in the case of the Cl- containing Samples 2 and 3. The TG experiment was carried out with a powder sample of about 50 mg wherein the temperature was ramped to 450° C. at a rate of increase of 10° C. per minute followed by a 2 hour hold and then cooling down to 100° C. A blend of 5% H₂ with the balance N₂ was then introduced into the microbalance and the temperature was increased again at a rate of 10° C. per minute to 450° C. The total weight loss of the samples in N₂ flow reflected the decomposition of BCC to the oxide while the weight loss in the presence of a H₂-N₂ mixture corresponded to the reduction of CuO to Cu metal.

In the present invention it has been found that the residual Cl impurity caused the observed change in BCC decomposition. This reduction behavior was confirmed by preparing a mechanical mixture of NaCl and the Cl—free Sample 1 and then subjecting the mixture to a TG decomposition reduction test. In particular, 25 mg of NaCl reagent was intimately mixed with about 980 mg BCC (Sample 1). The mixture was homogenized for about 2 minutes using an agate mortar and pestle prior to TG measurements.

The exact mechanism of the chloride action is unknown at this point. We hypothesize that the salt additive may incorporate in some extent in the structure of the source BCC weakening it and making it more susceptible to decomposition. On the other hand, the copper oxide produced upon thermal decomposition of BCC now contains an extraneous species that may affect key elements of the metal oxide reduction process such as H₂ adsorption and activation and penetration of the reduction front throughout the CuO.

Table 2 presents data on several samples produced by mixing different amounts of NaCl or KCl powder to the BCC Sample 1 listed in Table 1. The preparation procedure was similar to that described in paragraph [0021].

TABLE 2

| | | | | | Characteristic | |
|---|---|---|---|---|---|---|
| | | | | Pre- | temperature, ° C. | |
| | Basic Cu | | | treatment | BCC | CuO |
| | carbonate, | NaCl | KCl | temperature, | decom- | reduc- |
| Sample | (g) | (g) | (g) | ° C. | position* | tion** |
| 1 | #1 only | 0 | 0 | 400 | 335 | 256 |
| 2 | 9.908 | 0.103 | 0 | 400 | 296 | 352 |
| 3 | 9.797 | 0.201 | 0 | 400 | 285 | 368 |
| 4 | 9.809 | 0.318 | 0 | 400 | 278 | 369 |
| 5 | 9.939 | 0 | 0.150 | 400 | 282 | 346 |
| 6 | 9.878 | 0 | 0.257 | 400 | 279 | 378 |
| 7 | 0.981 | 0 | 0.400 | 400 | 279 | 382 |
| 8 | #1 only | 0 | 0 | 500 | 333 | 310 |
| 9 | 9.797 | 0.201 | 0 | 500 | 282 | 386 |

*Temperature at which 20 mass-% sample weight is lost due to BCC decomposition
**Temperature at which 5% sample weight is lost due to CuO reduction

The data also shows that both NaCl and KCl are effective as a source of Cl. Adding up to 1% Cl by weight affects strongly both decomposition temperature of BCC and the reduction temperature of the resulting CuO. It can be also seen that the combination of a thermal treatment at a temperature which is higher than the temperature needed for complete BCC decomposition and Cl addition leads to the most pronounced effect on CuO resistance towards reduction—compare Samples 3, 8 and 9 in Table 2.

Finally, the materials produced by conodulizing the CuO precursor—BCC with alumina followed by curing and activation retain the property of the basic Cu carbonate used as a feed. The BCC that is more resistant to reduction yielded a CuO—alumina sorbent which was difficult to reduce.

The following example illustrates one particular way of practicing this invention with respect of CuO—alumina composites: About 45 mass-% basic copper carbonate (BCC) and about 55 mass-% transition alumina (TA) produced by flash calcination were used to obtain 7×14 mesh beads by rotating the powder mixture in a commercial pan nodulizer while spraying with water. About 1000 g of the green beads were then additionally sprayed with about 40 cc 10% NaCl solution in a laboratory rotating pan followed by activation at about 400° C. The sample was then subjected to thermal treatment & reduction in the Perkin Elmer TGA apparatus as described earlier. Table 3 summarizes the results to show the increased resistance towards reduction of the NaCl sprayed sample.

TABLE 3

| | | Characteristic temperature | |
|---|---|---|---|
| | | of TGA analysis, ° C. | |
| | | BCC | CuO |
| Sample | Preparation condition | decomposition* | reduction** |
| 10 | Nontreated | 341 | 293 |
| 11 | Nontreated + activation | n/a | 302 |
| 12 | NaCl treated | 328 | 341 |
| 13 | NaCl treated + activation | n/a | 352 |

*Temperature at which 20 mass-% sample weight is lost due to BCC decomposition
**Temperature at which 5% sample weight is lost due to CuO reduction

Another way to practice the invention is to mix solid chloride and metal oxide precursor (carbonate in this case) and to subject the mixture to calcinations to achieve conversion to oxide. Prior to the calcinations, the mixture can be co-formed with a carrier such as porous alumina. The formation process can be done by extrusion, pressing pellets or nodulizing in a pan or drum nodulizer.

Still another promising way to practice the invention is to co-nodulize metal oxide precursor and alumina by using a NaCl solution as a nodulizing liquid. The final product containing reduction resistant metal (copper) oxide would then be produced after proper curing and thermal activation.

### EXAMPLES OF USE OF ADSORBENT

### Example 1

Thermodynamic data summarized in Table 4 show that the logarithm of the equilibrium constant of the S removal process is several orders of magnitude higher when the Cu component does not convert by reduction to Cu metal. This makes possible the achievement of very low residual S in the product with the reduction resistant adsorbents of this invention.

TABLE 4

| | Equilibrium Constant LogK | | | | | |
|---|---|---|---|---|---|---|
| | Temp, ° C. | | | | | |
| Reaction | 40 | 60 | 80 | 100 | 120 | 140 |
| CuO + H₂S(g) = CuS + | 20.7 | 19.5 | 18.4 | 17.4 | 16.6 | 15.8 |
| H₂O(g) | | | | | | |
| Cu₂O + H₂S(g) = Cu₂S + | 22.3 | 21.0 | 19.9 | 18.8 | 18.0 | 17.1 |
| H₂O(g) | | | | | | |
| Cu + H₂S(g) = CuS + H₂(g) | 3.78 | 3.43 | 3.12 | 2.85 | 2.61 | 2.39 |
| 2Cu + H₂S(g) = Cu₂S + H₂(g) | 8.8 | 8.2 | 7.7 | 7.2 | 6.8 | 6.5 |

### Example 2

Comparison of the reduction with H2 in a flow reactor of a prior art adsorbent and the adsorbent according the present invention. About 30 g adsorbent is heated with 5% H2-N2 gas mixture in a temperature programmed mode −2° C. /minute whereas the moisture content in the effluent is measured by a FTIR gas analyzer. The adsorbent of the invention (ADS-INV) reduces at higher temperatures than the reference adsorbent (ADS-REF) which does not contain any chloride. The progress of the reduction is followed by the water content in the effluent.

### Example 3

About 20 g adsorbent pressurized with about 2758 kPa (400 psig) hydrogen in a 300 cc autoclave. The pressure drop at ambient temperature is due to the adsorption of the reduction product water on the high surface area support. The picture shows that practically no pressure drop is observed with the material according to the invention ADS-INV while fast pressure drop is observed with the prior art material ADS-REF.

### Example 4

The autoclave testing method described in Example 3 is applied at a temperature of about 100° C. whereas the adsorbent phase composition is tested by X-ray diffraction after about 20 hours holding time. The adsorbent of the invention was still showing oxide phases Cu₂O and CuO while the regular material was converted to Cu metal almost completely

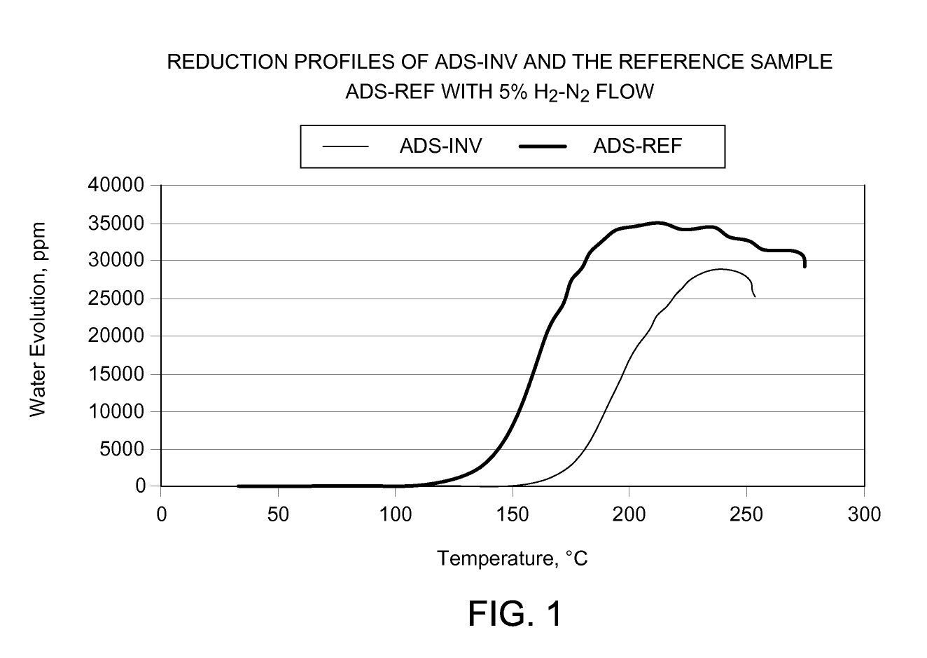

FIG. 1 is a comparison of the reduction curves of the adsorbent according the invention ADS-INV and a reference adsorbent ADS-REF which does not contain chloride. The reduction process is followed by the evolution of the product water

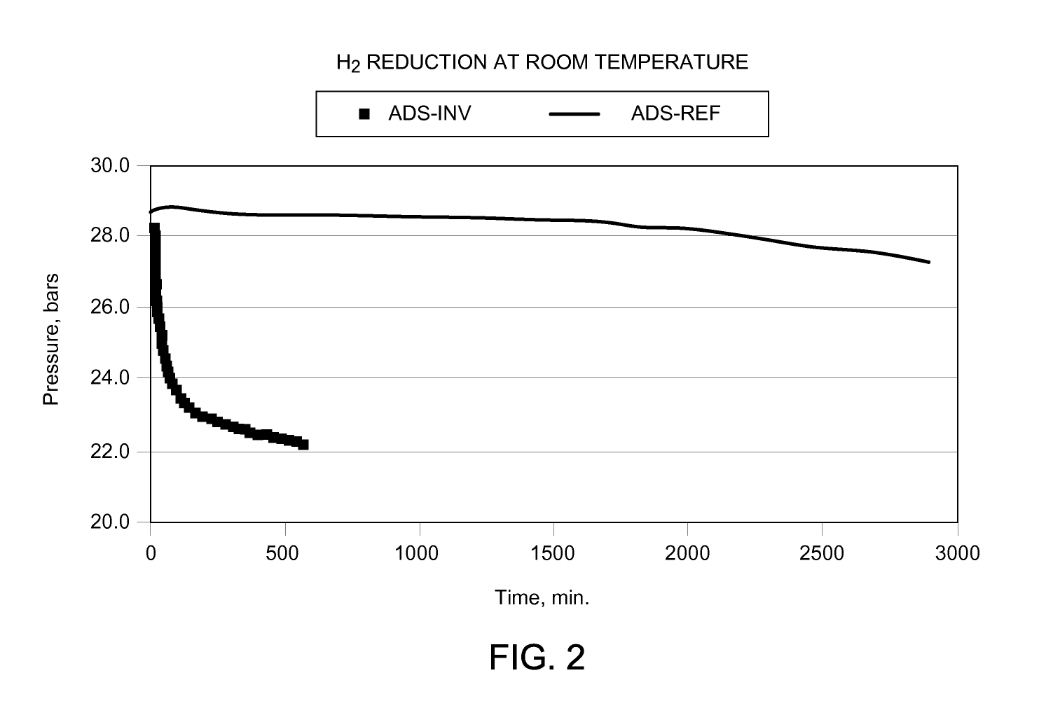

FIG. 2 is a comparison of the reduction of the adsorbent according the invention ADS-INV and the reference material ADS-REF. The reduction is followed by the decrease of the pressure due to H₂ consumption

1. A method of purifying a synthesis gas stream comprising contacting said synthesis gas with a sorbent comprising copper oxide and at least one halide salt and removing from said synthesis gas one or more impurities selected from the group consisting of mercury, arsenic, phosphorus and sulfur compounds and wherein said sorbent is not regenerated.

2. The method of claim 1 wherein said halide salt comprises sodium chloride, potassium chloride or a mixture thereof

3. The method of claim 1 wherein said sorbent comprises from 0.05 to 2.5 mass-% chloride.

4. The method of claim 1 wherein said sorbent comprises from 0.3 to 1.2 mass-% chloride.

5. The method of claim 1 wherein the said copper oxide is made from a copper carbonate comprising CuCO₃CU(OH)₂.

6. The method of claim 1 wherein said impurity is an arsenic compound.

7. The method of claim 1 wherein said impurity is a mercury compound.

8. The method of claim 1 wherein said synthesis gas stream comprises at least hydrogen and carbon monoxide.

9. The method of claim 1 wherein said synthesis gas is at a temperature from about 10° to 55° C.

10. The method of claim 1 wherein said synthesis gas is produced from hydrocarbons.

11. The method of claim 1 wherein said synthesis gas is produced from coal.

12. The method of claim 1 wherein said sorbent is not reduced by exposure to said synthesis gas stream.

13. The method of claim 1 wherein said impurity is a sulfur compound.
